(19) United States
(12) Patent Application Publication
(10) Pub. No.: US 2023/0220666 A1
(43) Pub. Date: Jul. 13, 2023

(54) Permanent Concrete Form

(71) Applicant: Marvin Richards Horton, San Francisco, CA (US)

(72) Inventor: Marvin Richards Horton, San Francisco, CA (US)

(21) Appl. No.: 18/183,752

(22) Filed: Mar. 14, 2023

(51) Int. Cl. E04B 2/86; B28B 1/087

(52) U.S. Cl. CPC E04B 2/8617; B28B 1/0873

(57) ABSTRACT

A Permanent concrete form (construction-block) for Structural Code monolithic reinforced-concrete. Construction blocks are sand-cement steel-reinforced side-panels, with one central embedded steel nut (3/4-10) [M20>2.5] that connects a threaded steel-tie-rod (or bolt) to a second side-panel. Tie-rod can also be #5 (16 mm) welded rebar. Typical side-panel size 500×250×40 mm (20″×10″×1.5″). The central single spacer tie-rod length is sized (width of wall) to provide space for concrete, rebar, thermal-insulation, conduits, ducts, and other embedment. Construction block tested for dry-stacking, and 3 m (10 ft) high anti-blow-out vibrated concrete placement.

### FIELD OF THE INVENTION

This invention relates to in-place monolithic concrete construction, more particularly to a permanent concrete forming system, whereby the form performs two functions, 1) to mold the flowable concrete, and 2) the form remains a permanent structural element.

### RELATED ART

Concrete for buildings has a substantial positive record of accomplishment, for 1) form-work cast-in-place, 2) factory pre-cast panels, beams, columns, piles, and 3) masonry-type installations. This invention combines the labor-time saving of masonry and the quality-strength of cast-In-place concrete construction. Masonry construction has evolved from fired clay bricks to concrete blocks, called “cinder-block” if made from light-weight aggregates, also known as concrete-masonry-unit (CMU). This in turn has changed from nearly solid blocks with 2 or 3 cavities to “Speed-Block” in typical USA size of 8″×8″×16″. Speed-blocks are intended to emulate the functionality-strength of cast-in-place reinforced (rebar) concrete. They have a 4″ high perpendicular separator that creates both vertical and horizontal channels for rebar and grout concrete. Speed-blocks require no vertical (head) mortar, and the blocks can even be dry-stacked with no horizontal mortar. This has made the cinderblock a very useful building material. However, this CMU suffers from some serious performance deficiencies.

Size: CMU size of 16″× L×8″ H×8″ W or 12″ W restricts many applications. If the design requires a larger monolithic concrete structure, CMU is not suitable.

Concrete and CMU have little thermal resistance. Some CMU contain partial insulation, but generally complete insulation requires constructing a second or third wall. Insulating Concrete Form (ICF) require additional wire-mesh stucco or plaster on both outer and inner wall surfaces, or other type of surface treatment.

Reinforced grout or concrete must have complete bonding to the rebar to obtain the strength of a composite material. This bonding is by rigorous internal vibration compaction, which require strong rigid forms. This concrete vibration consolidation has caused CMU to fracture “blow-out”; thus some CMU building is done without or little vibration, which results in a poor structure, and sometimes in catastrophic failure.

### SUMMARY OF THE INVENTION

FIG. 06: This construction block 100 was developed, whereby complete Code monolithic reinforced concrete structures, including: interior and exterior surface, thermal-insulation, moisture protection, acoustical-barrier, electrical-mechanical utilities are all provided by a single element. Of particular interest are schools, hospitals, police stations, military installations, government offices, religious facilities, prisons that have a real reason for added durability to resist natural disasters (seismic, hurricane, flooding) and unfortunately, terrorism and war. Also, industrial, commercial, scientific, cultural, dormitory buildings will also benefit from this invention. This invention can incorporate an integral thermal-insulation element that can significantly reduce heating and cooling cost.

This invention has two major parts FIG. 08: a 3000 psi (20 MPa) concrete steel reinforced 110 side-panel (max. nom. 500×250×40 mm), and a steel tie-rod (nom. Ø20 or 16 mm) 120. This construction-block 100 has two opposed side-panels 110 connected (threaded or welded) by a single tie-rod 120. The thermal insulation 150 (if required) is normally adhesively attached to the inside of the side-panel forming the inside of a wall, so that the structural mass of concrete protects the insulation from any outside rain or water. Example: the width of a typical construction block 100 for a 14″ wide wall is: 1.5″ outer-panel+8″ reinforced-concrete+3″ foam-insulation+1.5″ inner-panel. (Metric: 40+200+75+40=355 mm: Block Wt. 20 kg).

This Invention eliminates most concrete form-work, which creates large savings in labor, materials, and time; while meeting size, strength and thermal for reinforced concrete projects.

Stockpiling the parts (side-panel 110 and tie-rod 120) for construction block 100 will enable the timely repair of critical infrastructures (i.e., water, sanitation, power, electrical, communication), or to erect permanent structures in lieu of temporary facilities. This construction block configuration can be used as an emergency “flood control sand-bags” by placing and filling with sand; or used as a temporary compound security wall, with the height no more than twice the width, when filled with sand or gravel. This invention enables skilled & semi-skilled crews to rapidly erect permanent Code Compliant monolithic reinforced-concrete buildings, structures, facilities for industrial, commercial, military use.

The construction block 100 unique versatility and strength of 3000 psi (20 MPa) reinforced concrete side-panels 110 (max: 20″×10″×1.5″) connected by a single tie-rod 120, allows for high vibrated concrete casting loads.

If a building site is enclosed on 3 sides by existing structures, the construction block 100 can be used to erect a new building totally from the inside of the site.

### BRIEF DESCRIPTION OF THE DRAWINGS

FIG. 02: Welded steel reinforcement for side-panel.

FIG. 04: Half-block or mitered block.

FIG. 06: Construction-block, tie-rod and optional block-out.

FIG. 08: Construction block installation options.

FIG. 10: Insulated side-panel rotated to fit thru vertical rebar.

FIG. 12: Mitered insulated side-panels for a 90-degree wall comer.

FIG. 14: Structural foundation and wall with insulation and utilities.

FIG. 16: Square (or round) wall corner using steel fabricated parts.

FIG. 18: Bolt clip to clamp fabricated form parts to side-panels.

FIG. 20: Remove fabricated form parts.

FIG. 22: Wide foundation round corner with bolt-clip and steel strip.

FIG. 24: Wide foundation round corner using mitered side-panels.

FIG. 26: Intersecting walls, outer wall thickness increased for insulation.

FIG. 28: Max spacing for vertical rebar for maximum strength/rigidity.

FIG. 30: Column example for crane-rails, or roof load.

FIG. 32: Steel frame for doors, windows, hatches, utilities.

FIG. 34: Steel channel frame for wall openings.

FIG. 36: Machine to make construction block side-panels.

FIG. 38: Detail side-panel mold and eject.

FIG. 40: Lifting-plate adjusting locknuts.

FIG. 42: Electromagnetic chuck to engage side-panel anchor-nut.

FIG. 44: Electromagnetic parts, section view.

FIG. 46: Steel reinforcement for side-panel with welded anchor-nut.

FIG. 48: Locating welded anchor-nut on brass-stem.

FIG. 50: Mixing and compacting steel slider.

FIG. 52: Electric compaction vibrator.

FIG. 54: Hydraulic motor and auger drives.

FIG. 56: Hydraulic motor (front view).

FIG. 58: Upper and lower augers bearings.

FIG. 60: Loading pallet and reinforcing into side-panel mold.

FIG. 62: Loading pan and reinforcing into side-panel mold.

FIG. 64: Slider moved forward to vibrate, compact and fill mold.

FIG. 66: Slider moved back to re-fill mixer and expose side-panel.

FIG. 68: Pallet and side-panel hydraulically ejected.

FIG. 70: Side-panel with pallet covered and set in curing racks.

FIG. 72: Harden side-panel separated from pallet or pan.

FIG. 74: Hydraulic cylinder rod engages anchor-nut.

FIG. 76: Electromagnets hold steel pallet or pan.

FIG. 78: Side-panel machine in cleaning mode.

FIG. 80: Welding Jig for side-panel steel reinforcement.

FIG. 82: Detail for securing and welding anchor-nut.

FIG. 84: Side-panel reinforcement options.

FIG. 86: Testing apparatus for side-panel anchor-nut.

FIG. 88: Welding alignment fixture to make a fixed-width construction block.

FIG. 102: Flat wood or plastic side-panel mold option.

FIG. 104: Detail of side-panel flat mold and press/stamp (decorative) plate.

FIG. 106: Detail of flat-head clamp screw.

FIG. 108: Installing side-panel reinforcement into mold.

FIG. 110: Filling mold with wet sand-cement.

FIG. 112: Stacking molds for 7 days for cure.

FIG. 113: Mold rotated and submerged in water after screw is removed.

FIG. 114: Mold set on frame to remove harden side-panel.

FIG. 120: Drum mixer for continuous side-panel casting.

FIG. 122: Drum mixer with vibrator rotated for cleaning.

### REFERENCE NUMERALS FOR DRAWINGS

Dimensions are listed only for clarity, and do not limit the scope of the invention, Numbers O to 99 are non-patent items, 100 and over are patent items.

40: Construction items (pipes, conduits, fittings).

50: Concrete reinforcing steel bars (rebar).

52: Concrete

100: Complete Construction-Block (two panels with tie-rod).

101: Mixture of aggregate, cement, water.

102: Steel rod hot-rolled, (0.25″ (Ø6 mm)).

104: Steel A36 flat (typical: 1″×6″×⅛″ (25×150×3 mm)).

105: Steel reinforcement for side-panel (102+104+106).

106: Square steel anchor-nut (typical: ¾-10); [M20×2.5].

107: Bent 1″×6″⅛″ A36 flat (no anchor nut).

108: Side-panel cut or mitered from a full-sized side-panel.

110: Full size (typical: 500×250×40 mm) steel reinforced side-panel.

120: Steel tie-rod: threaded rod, ¾-10; [M20×2.5]; or weldable ⅝ rebar.

122: Tie-rod threaded adapter, typical for connecting rebar.

124: Lock nut for threaded tie-rod (¾-10).

130: Steel clip welded nut with bolt.

132: Steel sheet.

150: Thermal Insulation (rigid foam boards).

175: Fabricated steel (frame for doors, windows, hatches, utilities).

200: Mold and eject assembly.

202: Steel angle mold.

203: Eject rod steel lift plate.

204: Steel bottom mold plate.

205: Hydraulic cylinder, 4″ (100 mm) stroke.

206: Eject rods, SS 304, 4 each, Ø½″ (12 mm), ½-13 partial thread.

207: Lock nut to level the rod-eject-plate.

208: Drainpipe and hydraulic cylinder support, (steel 1½″ sch.40 pipe).

210: Electromagnet to hold anchor-nut during mold compaction.

212: Electromagnet stem to locate side-panel anchor-nut.

214: Rubber sleeve to protect the anchor-nut-threads from cement paste.

216: Electromagnetic (A36) steel core, 1.5″Ø×5″ (38Ø×127 mm).

217: Non-magnetic mounting disc (delrin), 5″Ø×0.75″ (127×20 mm).

218: Electrical-insulating mounting tape (2″×0.0056″).

219: Electrical heat-shrink tube, 3″ Ø(Ø75 mm).

220: Magnet wire (enamel copper), 20 g, 900 ft, 7588K61.

221: Steel Ø3″ EMT tube used as outer case.

222: Mounting bolts, Ø 5/16″ (M8×1.25), 8 each.

223: Insulating disc, delrin, Ø3″ (75 mm)×0.063″ (1.6 mm).

224: Bottom case disc, steel, Ø3.25″ (83 mm)×0.063″ (1.6 mm).

225: Brass screws for electric connection.

226: Casing retainer bolt, Ø⅜-16 (M10×1.5).

230: Mixer-Compactor Assembly (Slider).

230A: Compactor box.

230B: Auger mixing chamber.

232: Angle steel frame, 2″× 3/16″.

234: Sliding strips, 2″×0.25″ PTFE (teflon).

236: Two each horizontal hydraulic cylinders, 16″ stroke, bracket.

238: Steel pipe 5″ I.D. for discharge Ø4″ (100 mm) auger bearing.

240: Access hole Ø4.25″ (108 mm) for Ø4″ mix-discharge auger.

242: Access hole, Ø3.25″ (83 mm) for Ø3″ mixing auger.

244: Access hole, Ø3.25″ (83 mm) for Ø3″ mixing auger.

246: Steel plate to mount Power-Unit with 8 bolts.

248: Steel bracket to mount vertical hydraulic cylinder for compaction unit.

250: Vibration compaction assembly.

252: Steel plate, 20″×10″×⅜″ (500×250×10 mm).

254: PTFE (teflon) anti-stick sheet, 20″×10″×0.25″ (500×250×6 mm).

256: Electric vibrator, 0.75 Kw, 3400 rpm, 110 VAC, 1 phase, 350 kgf.

258: Steel posts 4 each to keep vibrator plate level.

260: Hydraulic cylinder, 2″ bore×10″ stroke×1.25″ rod, lift/lower vibrator.

262: Pipe, ¾″ sch40 steel, support arm.

264: Steel plate for 4 each wire-rope attachment.

266: Wire-rope end-fitting ¼-20 threaded, 300 lb. cap., 8 each.

268: Wire-rope, 18-8 SS, 7×19, ⅛″, 350 lb. cap, 4 each.

270: Mix-discharge power drive unit.

272: Mix Ø3″ auger, 2 each. Pitch direction of 3″ augers reversed from 4″ auger.

274: Mix-discharge Ø4″ auger: mixes feeding to back, discharges feeding to front.

276: Mix-discharge power mounting plate and bracket, matching 8 bolts.

280: Hydraulic motor, Ø1″ shaft, 24 in3/rev, 6840 in-lbs., 2250 psi, max 190 rpm.

281: Jaw-coupling, 1″×1″ bore, Ø2.53″×3.5″ length (L-100).

282: Bearing block, delrin, 1 each, 8″×8″×2″ (200×200×50 mm): 3 shafts w/oil.

283: Bearing block, delrin, 1 each, 8″×2″×2″ (200×50×50 mm): 2 shafts w/oil.

284: Roller-chain sprocket, ¾″ bore, 3.14″ O.D., 2 each, for Ø3″ mix augers.

285: Cylindrical bearing, delrin, 5″ O.D.×4″ I.D.×3.19″ long: for Ø4″ auger.

286: Roller-chain sprocket, 1″ bore, 4.10″ O.D. for Ø4″ mix/discharge auger.

287: Lubrication oil holes

288: Roller-chain, #40, ½″ gage.

300: Pallet, flat or corrugated steel, with Ø2″ hole for magnetic clamp.

302: Pan, flat or corrugated steel with 2″ hole for magnetic clamp.

306: Steel or plastic cover sheet (flat or curved-edges) for curing.

310: Steel Ø⅜″ (10 mm) rods for panel curing rack.

312: Steel Ø2″ vertical pipe for Ø⅜″ curing rack rods.

314: Steel HSS 3″×4″×0.125″ curing rack bottom frame.

320: Hydraulic cylinder, 1.5″ bore×6″ stroke×½″ rod, 12½″ length.

324: Commercial electromagnet, 4 each, (24 vdc, 30 w, 4.5″×2.5″×2″).

326: Steel angle, 2″×2″× 3/16″ and ⅛″ sheet.

328: Magnet mounting sheet, ¾″ HDPE (non-magnetic).

350: Mounting plate for welding-jig for side-panel steel reinforcement.

352: Centering pin to clamp anchor nut to bar for welding.

354: Spring strip & bolt.

370: Panel-block testing apparatus.

372: Rubber mat. 2 each, 9″×7″×0.25″ (225×180×6 mm); load area.

374: Steel plate,2 each, 9″×7″×0.25″ (225×180×6 mm); compression load.

376: Threaded rod (¾-10) to engage embedded anchor-nut.

378: Threaded rod, ¾-10, jacking-screw to load test side-panel.

380: Drive nuts to raise bar-frame, each side rotated evenly.

382: Steel rectangle tube (HSS) 3″×4″×0.25″

384: Load-cell, 0 to 10,000 lbs. (44,480 N) force.

400: Welding fixture to make a complete fixed width construction block.

401: Frame steel channel C 4×5.4, I=3.85 in4, S=1.93 in3.

402: Steel tube 1.05″ I.D., 4 each.

404: Steel rod 1″ O.D., 2 each.

406: Hydraulic Cylinder, 2 each, 2″ bore, 24″ stroke, 1.25″ rod, 32″ length, 3000 psi.

408: Hydraulic rotary flow divider, SAE 8 (to synchronize two cylinders).

410: Hydraulic power, 2 Hp, 115/230 vac, 1.3 gpm @2000 psi, double-acting 4-way valve.

500: Drum mixer, steel, 5 Hp electric motor, reduction-gear driven.

502: Drum mixer bottom discharge Ø4″ auger.

504: Spiral mixing blades.

550: Wood form (23″×12″× 23/32″ plywood, 1.5″×1.5″ wood).

552: Flat-head screw, ¾-10×1¼, Mc 91253A838.

554: Drive pin ⅝ Ø×6″ (to remove side-panel from mold).

556: Square tube or wood stand to receive side-panel from mold.

558: Water tank, 24″ L×16″ W×6″ D, metal or plastic.

560: Water to submerge side-panel.

562: Press/stamp plate attached to mold bottom.

### DETAILED DESCRIPTION OF THE INVENTION

The descriptions below contain many specifications, which come from prototype and experimental tests. These should not be construed as limiting the scope of the embodiments, but as merely providing illustrations and scale to the embodiments. USA units, inches are used to conform to actual USA purchased materials. A typical side-panel is cast from about 2.5 parts #30 sand to 1 part Portland cement by weight. The essence of the construction block is a single tie-rod configuration, which allows for placing rebar in the best structural positions, adjusting foundation or wall width for soil loading or structure strength, and space for thermal insulation and other embeds.

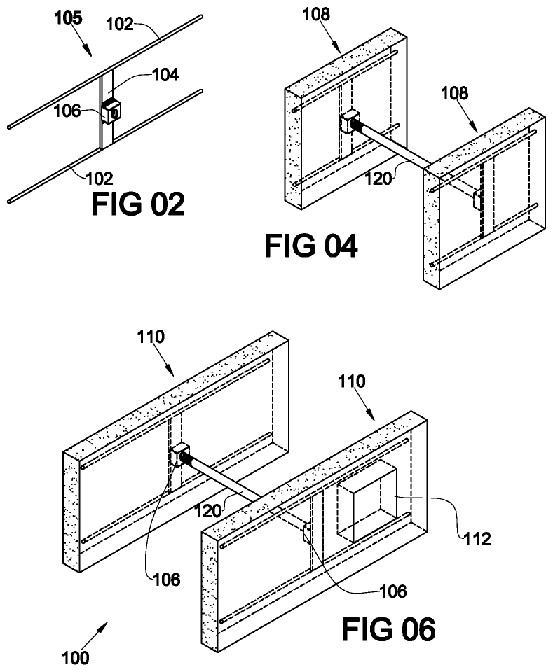

FIG. 02: The side-panel steel reinforcement 105 is 2 each ¼″ rods×18″, welded to 6″×1″×⅛″ flat. Anchor-nut ¾-10 steel square nut is welded to the 6″ flat for single center connection.

FIG. 04: A half-block or mitered block 108 is made by cutting the ends of a full side-panel.

FIG. 06: A construction block 100 is formed by connecting two each side-panels 110 with a single tie-rod 120 a ¾″ (20 mm) threaded-rod; 112 is a block-out for an electrical wiring box.

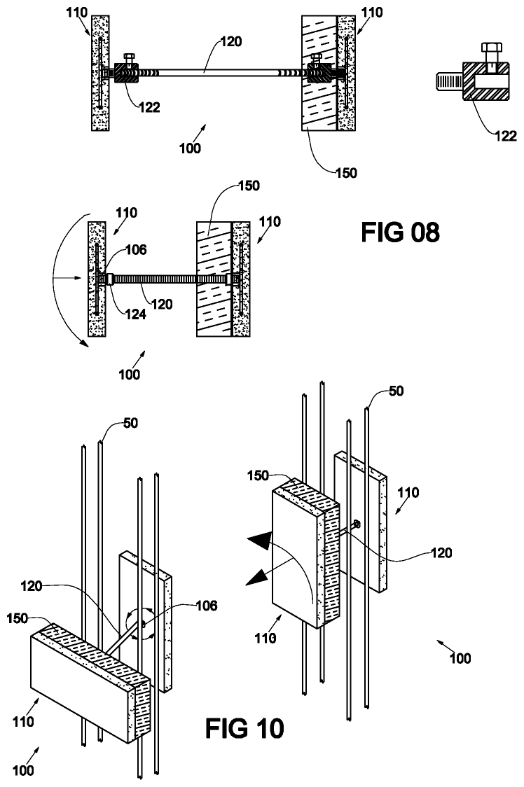

FIG. 08: Threaded-rod 120 with lock-nut 124. Adapter 122 with rebar 50 is used for tie-rod 120.

FIG. 10: Construction block advantage by rotating or removing side-panel to fit thru congested rebar.

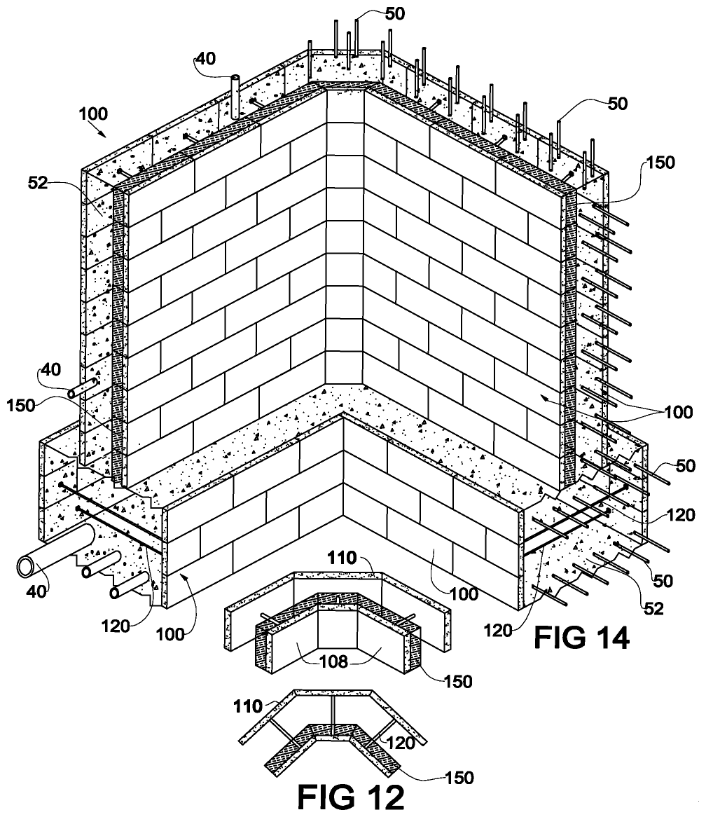

FIG. 12: The building corner panel 108 is from mitered standard side-panel 110.

### Use of Invention: Construction-Block

FIG. 14: Example of a structural foundation and wall using insulated 150 construction block 100. Shown is space for rebar 50, pipe & conduits 40.

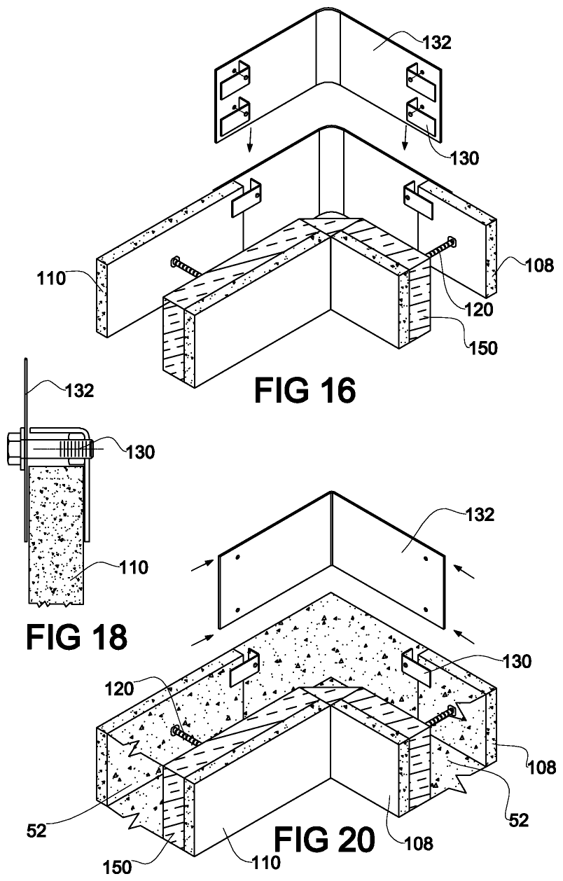

FIG. 16, 18, 20: Alternate building corners with sheet steel and special clamps.

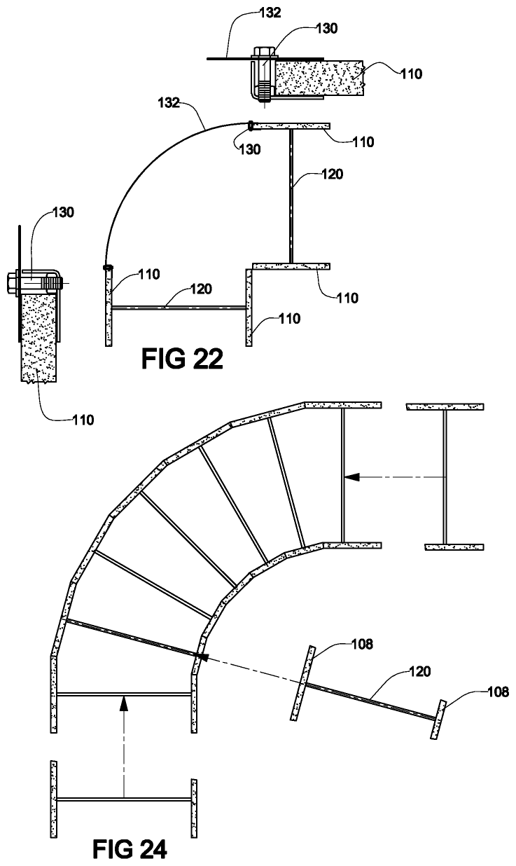

FIG. 22: A large corner radius with sheet steel and clamps.

FIG. 24: A corner radius using 1-meter-wide mitered construction blocks 108, tie-rod 120.

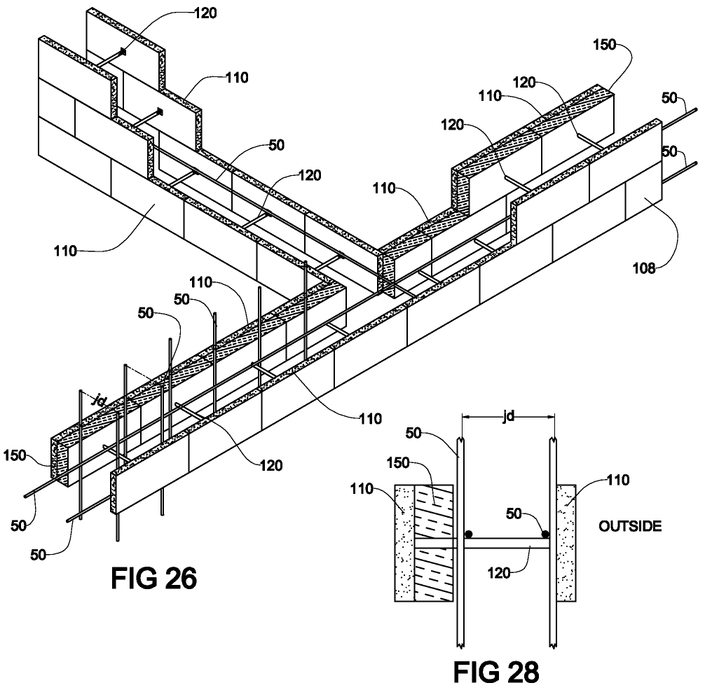

FIG. 26: Increased width for the insulated outer wall; with insulation 150 on inside of the inside side-panel 110; outside wall intersecting with an inner wall; some typical rebar 50 reinforcing.

FIG. 28: The strength moment-arm “jd” is maximum for the size of the block 110 and insulation 150.

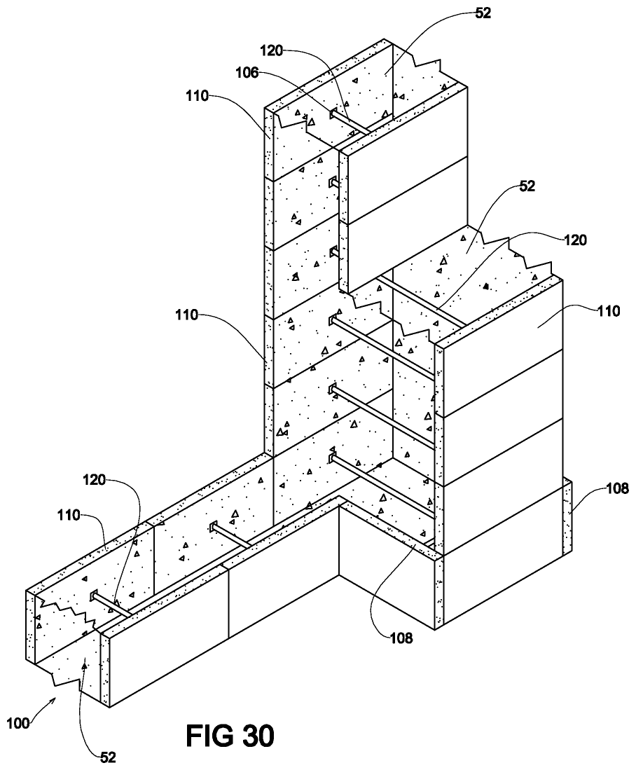

FIG. 30: A structural wall 110 & 120 tie-rod (rebar & insulation not shown) incorporating a column for crane rails or roof trusses or other heavy loads, concrete 52.

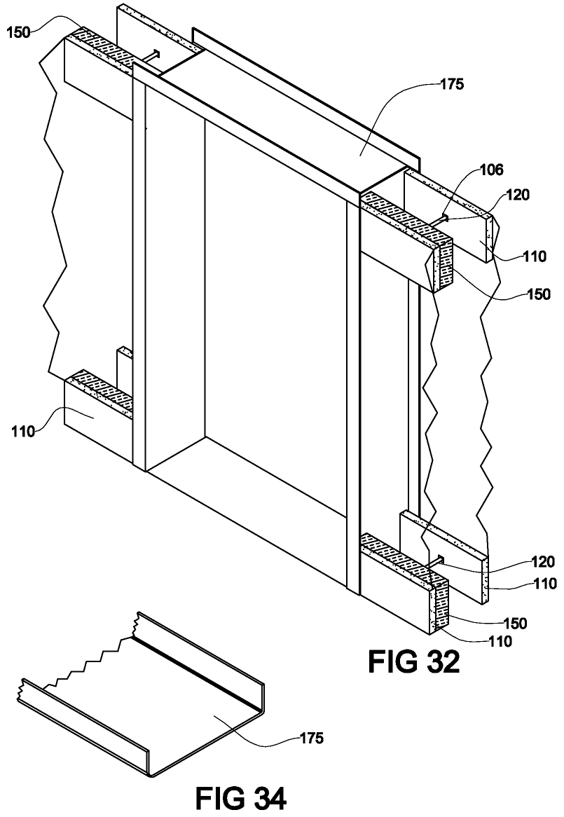

FIG. 32: Door, window, hatch openings with structural steel components.

FIG. 34: Typical fabricated steel channel 175.

### Machine to Make Construction-Block Side-Panel

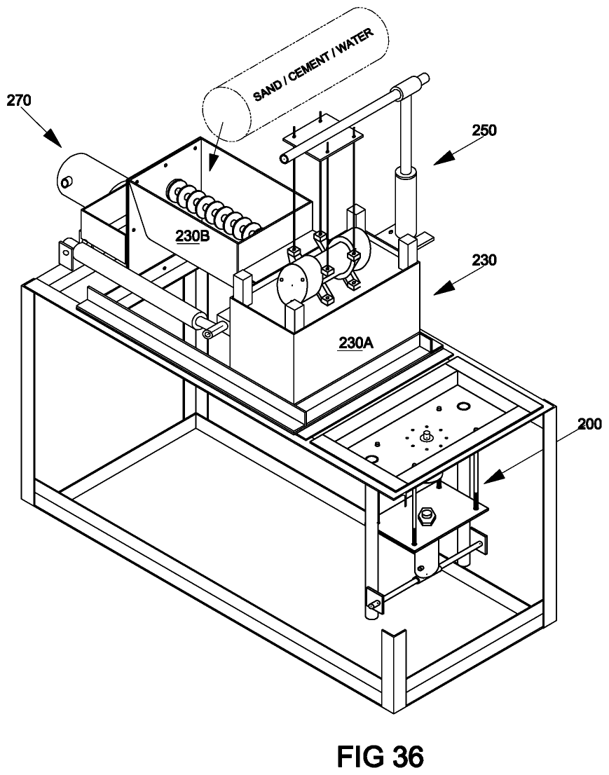

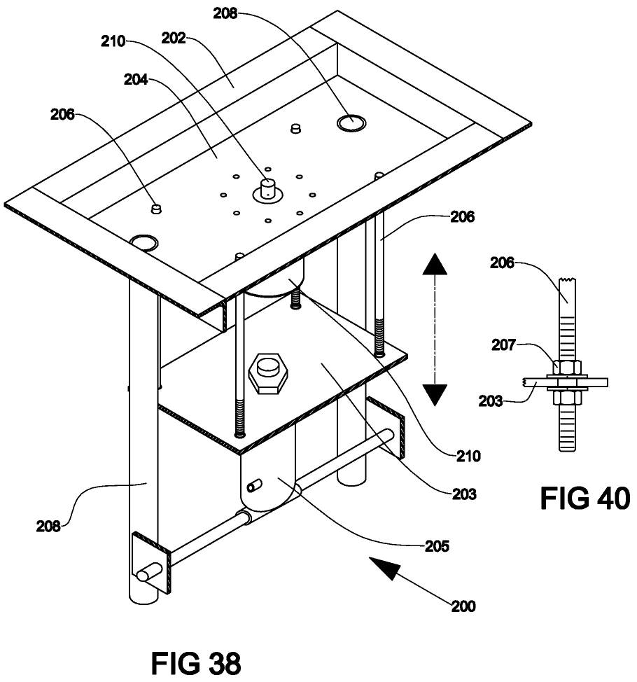

FIG. 36: The main components of the side-panel manufacturing machine. Mold-Eject 200; Mixer-Compactor (slider) 230A, B; Vibrator 250; Auger Power 270. Sand/cement/water delivery not part of patent.

FIG. 38: Angel-steel 2″×2″×0.19″ (50×50×5 mm) mold 20″×10″×1¾″ (500×250×45 mm) 202. Bottom steel plate, 20″×10″×¼″ 204. Eject-rods, SS 18-8, 4 each, ½″Ø×12″ 206. Eject-rod steel plate 12″×8″×¼″ 203. Hydraulic cylinder, 3″ bore×4.375″ stroke×1¼″ Ø rod, rod-end 1″-14 (pipe-thread), length 11.38″, 3000 psi, ¼″ NPT, pinhole 1″ 205. Drainpipe and hydraulic cylinder support 1½″ sch40×22″ galvanized steel pipe, 2 each 208.

FIG. 40: Eject-rod level/lock nut ½-13, 8 each 207. Electromagnet 210 to securely position and hold panel anchor-nut 106 during vibration molding compaction.

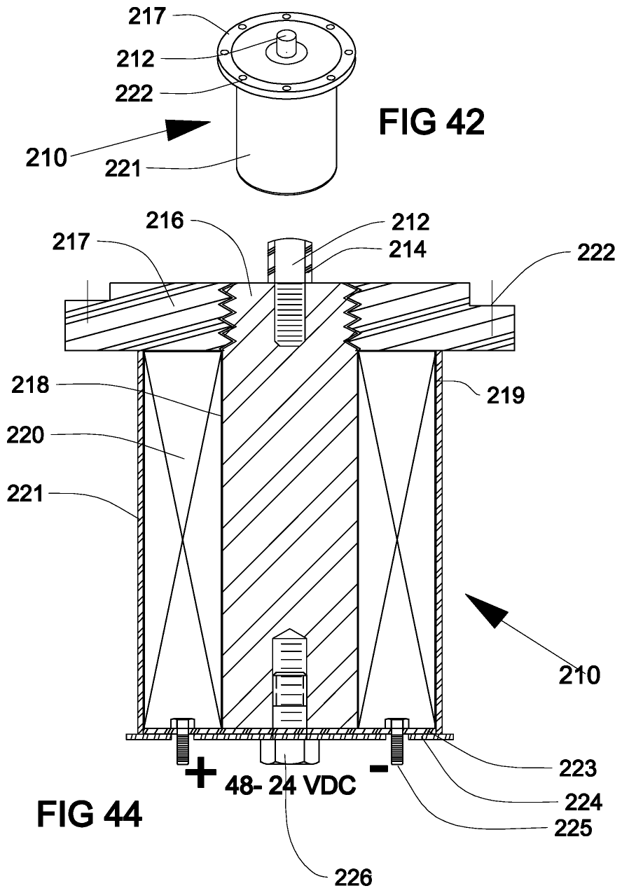

FIG. 42, 44: Electromagnet 210 to align and hold panel anchor-nut 106. Electrically switching the DC the electromagnet is quickly turned on and off for rapid production cycling rate. Cut-a-way of special electromagnet 210. The Ø5″×¾″ (Ø127×20 mm) delrin mounting disc with Ø 5/16″, 8 bolt holes, is drilled 1 11/32″ (1.343rdia). And taped for 1½″-6 threads, 217. The delrin is non-magnetic so that the magnetic force is directed thru the stem 212 and anchor-nut 106. The 1½″×5″ (38×127 mm) A-36round steel core 216 (magnetic circuit) is threaded 1½″ Ø×6 (threads per inch) for ¾″ for disc thickness. Bottom of core taped ⅜-16 for case retainer screw 226. Electrical insulation is provided by insulating-tape 218, heat-shrink tube 219, delrin disc 223. Solenoid coil winding 220 is 20 gage (0.0320″, 0.812 mm) enameled copper wire (mag-wire), 0.0333 ohms/1000 ft. Voltage is 24 to 48 vdc, connected thru screws 225. Steel outer case is Ø3″ EMT (Electric Metallic Tube), 221: bottom disc is Ø3¼″×0.063″ (83×1.6 mm), both for magnetic circuit 224.

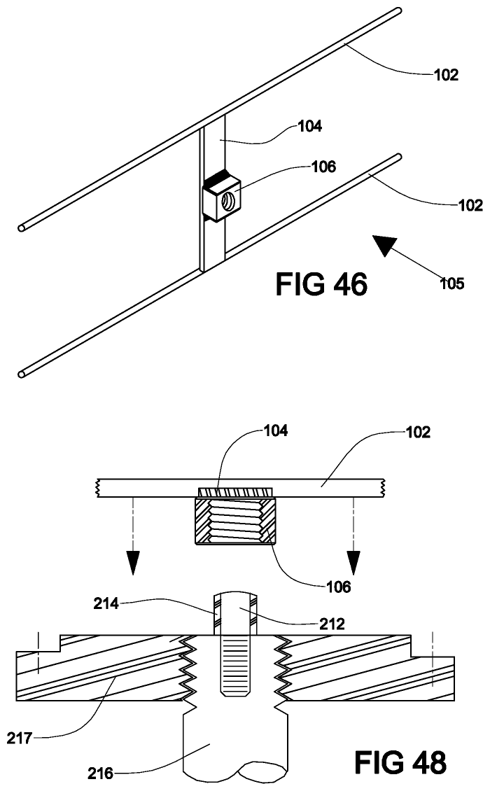

FIG. 46: Preferred embodiment of side-panel reinforcement 105, with anchor-nut 106.

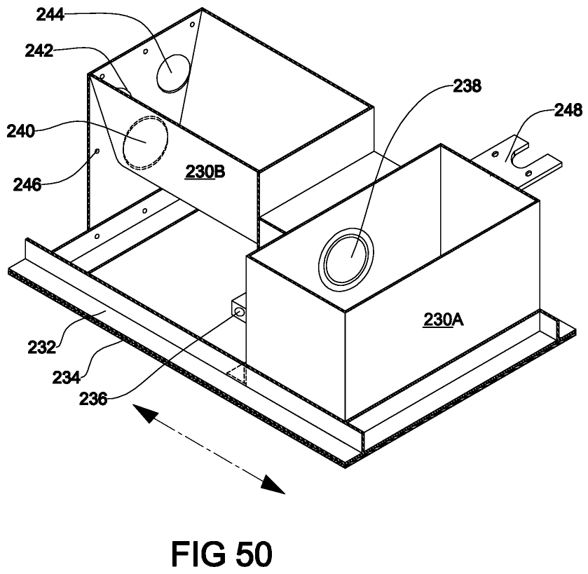

FIG. 48: Mating of anchor-nut 106 and rubber-sieve 214 on magnetic stem 212 to maintain critical nut alignment during panel vibration molding.

FIG. 50: Steel welded assembly (slider) 230 A-B. Steel angle 2″×2″× 3/16″ and 3/16″ steel plate. Sliding strips PTFE (Teflon) 2″×¼″ (50×6 mm) attached by #8-32 screws to all bottom angle sliding surfaces 234. Bolt holes, 8 each, 246 for ⅜″-16screws to attach auger power plate. Discharge port of 5″ sch.40 pipe×3 long with Ø4″×3″ delrin auger bearing 238. In back plate, access holes for augers, 2 each Ø3¼″ [242 & 244]; and 1 each Ø4¼″ 240. Sliding hydraulic cylinder rod mounting bracket, 2 each, 236. Bracket 248 for vertical hydraulic cylinder 260 for vibrating-compacting unit 250.

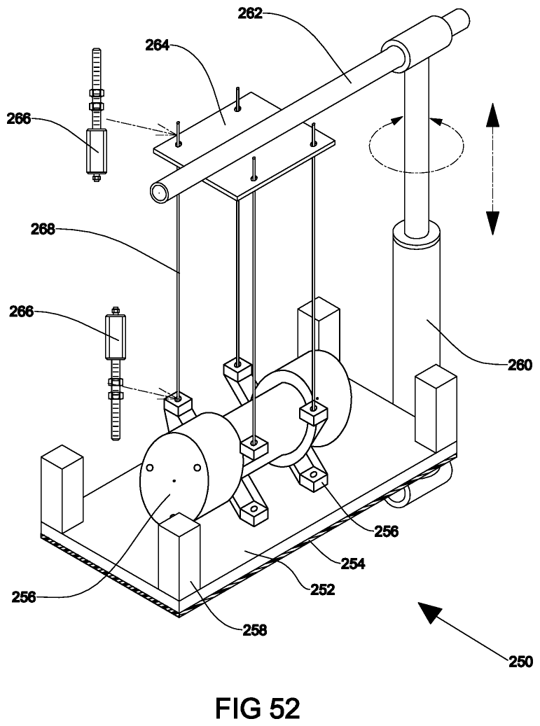

FIG. 52: Vibrating-compaction assembly 250. Electric vibrator (110 vac, 0.75 kw, 1 ph, 3400 rpm 350 kgf) 256, bolted to steel plate 20″×10″×⅜″ 252. Steel plate has 4 each 1.5″×1.5″×4″ (38×38 ×100 mm) guide bars 258 to keep vibrating-compaction plate 252 level in slider 230A To slide freely from the wet just-formed panel, a 20″×10″×¼″ (500×250×6 mm) teflon sheet 254 is attached to the bottom of the steel plate with #10-24 screws. This is necessary to prevent the wet sand/cement mix from tearing as the slider moves back to expose the new panel to be ejected. The vibrator-motor 256 and plate assembly 252 are lifted/lowered by 4 each 268 ⅛″ wire-ropes supported by a steel plate 264 and a Ø1″ pipe 262 that is attached to a vertical hydraulic cylinder 260. This concentrates the vibratory force into the side-panel mold 202 & 204. The wet sand-cement side-panel is consolidated only by the vibration and weight of the steel plate assembly. Wire rope 268 is connected by adapter 266, wire-rope end fitting, ¼-20 threads into motor 256 & plate 264.

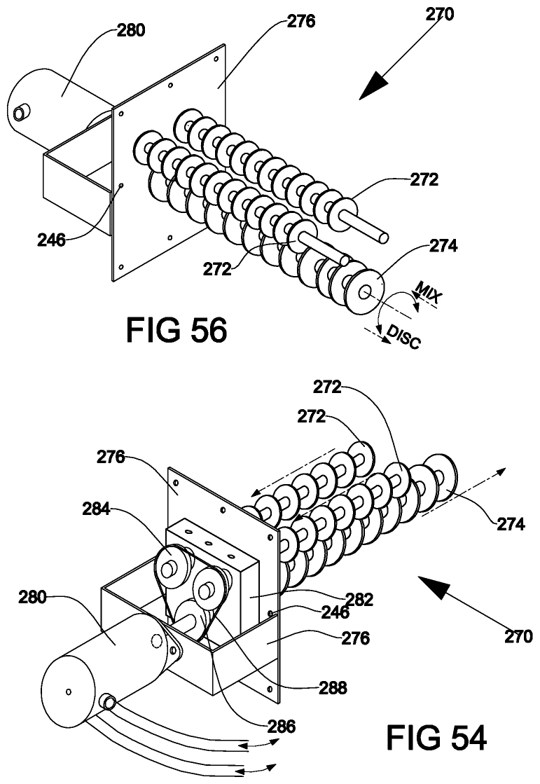

FIG. 54: (back view) & FIG. 56 (front view): Mix/discharge auger assembly. The auger assembly has 3 augers: one Ø4″ 274 and two Ø3″ 272 (nominal diameters). All 3 augers turn in the same direction (chain-drive 288 & 284) as the reversible hydraulic-motor 280. The blade-pitch of the upper 3″ augers is reversed from the 4″ bottom auger. In mixing-mode: the bottom 4″ auger feeds to the back and the two each 3″ augers feed to the front. Thus, moving the mixture from bottom to top of mixing chamber 230B. In discharge mode: the hydraulic motor reverses rotation, so that the bottom 4″ auger feeds to the front discharge port, and the upper two each 3″ augers feed to the back. thus, supplying mixture to the 4″ auger. Auger-power plate 276 bolts to mixer plate 230 with bolts 246.

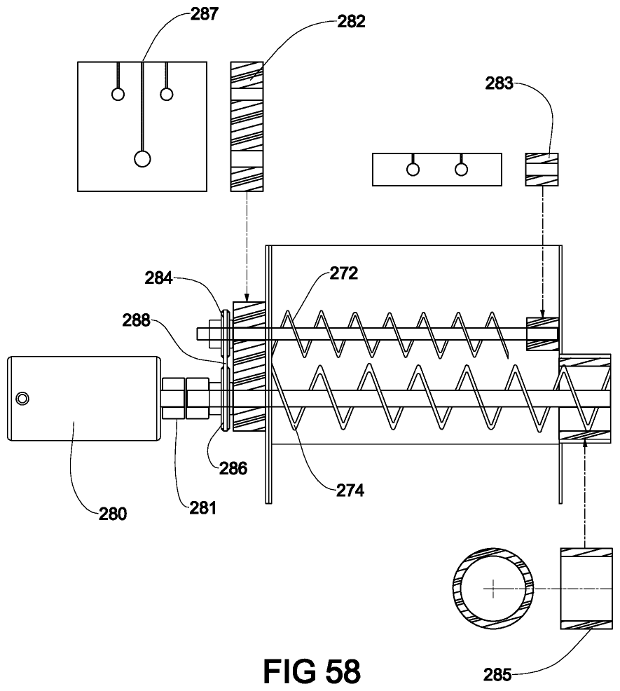

FIG. 58: The bearing arrangements for the augers 274 & 272. Also, hydraulic-motor 280, coupling 281, chain-drive 284, 286, 288, listed under Reference Numerals.

### Process To Manufacture Construction-Block Side-Panel

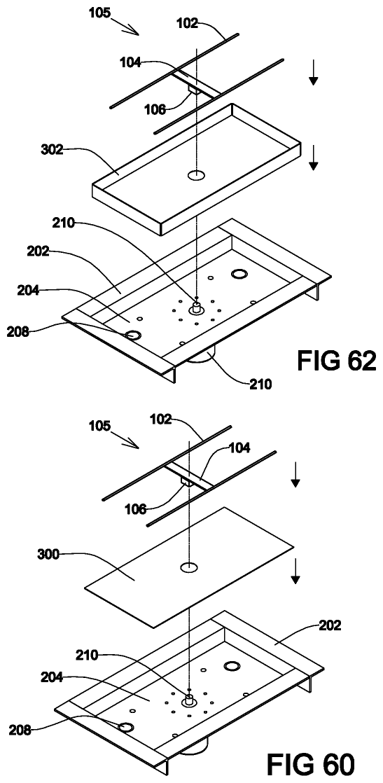

FIG. 60: The process for making a side-panel. The mold 204 & 202 is rinsed clean, a pallet 300 (usually flat steel sheet) is placed, side-panel reinforcing 105 is set so the anchor-nut 106 fits over the magnetic-stem 214, and the electromagnet 210 is switched on.

FIG. 62: is similar, except a pan with sidewalls 302 is used in place of a pallet.

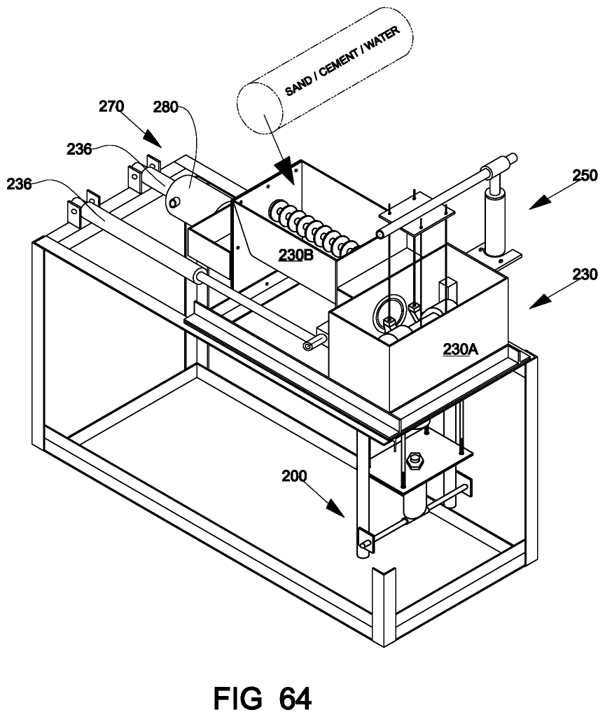

FIG. 64: Mix-compactor 230 has been moved forward by hydraulic cylinders 236 to cover mold-eject 200. The hydraulic-motor 280 had been rotating in discharge direction to fill compactor section 230A with mixed sand cement water for one panel. Hydraulic-motor 280 is reversed so mixer 230B can accept material for the next cycle. Vibrator assembly 250 is lowered, vibrator-motor is run to compact and mold a new side-panel over the installed pallet and embedded reinforcing.

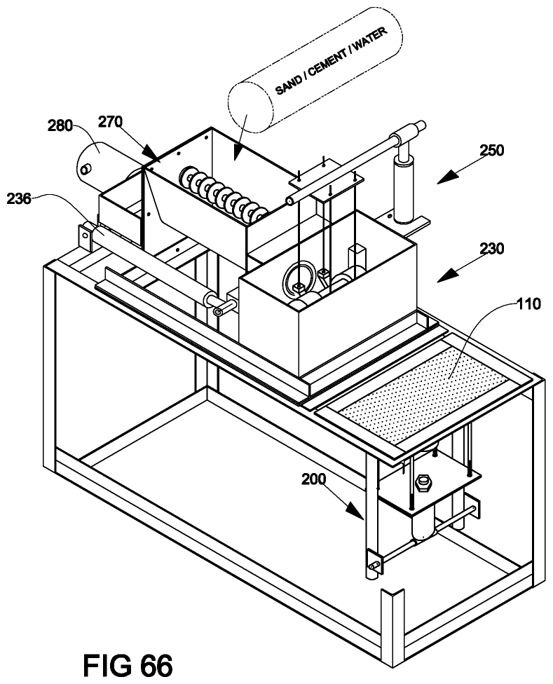

FIG. 66: Mix-compact slider 230A-B moved back to expose and screed a new panel 110. Hydraulic motor 280 is mixing the next load. After mix-compact 230A-B is at back position, vibrator 250 is hydraulicly lifted to up position and the electromagnet 210 holding the side-panel reinforcing 105 is turned off.

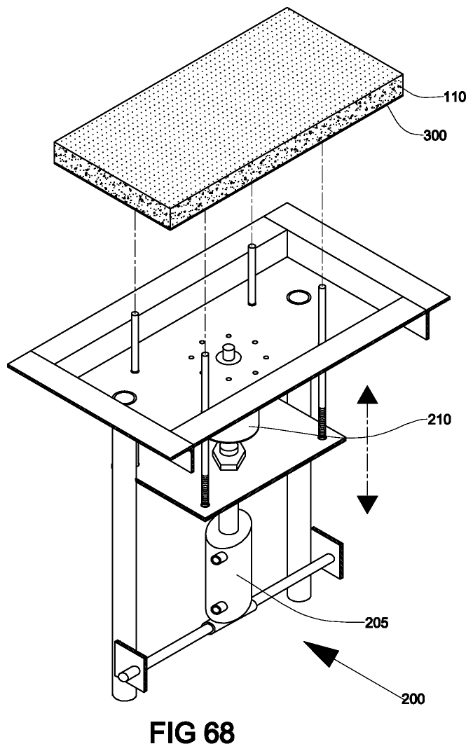

FIG. 68: The side-panel 110 with pallet or pan 300 or 302 is ejected by hydraulic cylinder 205.

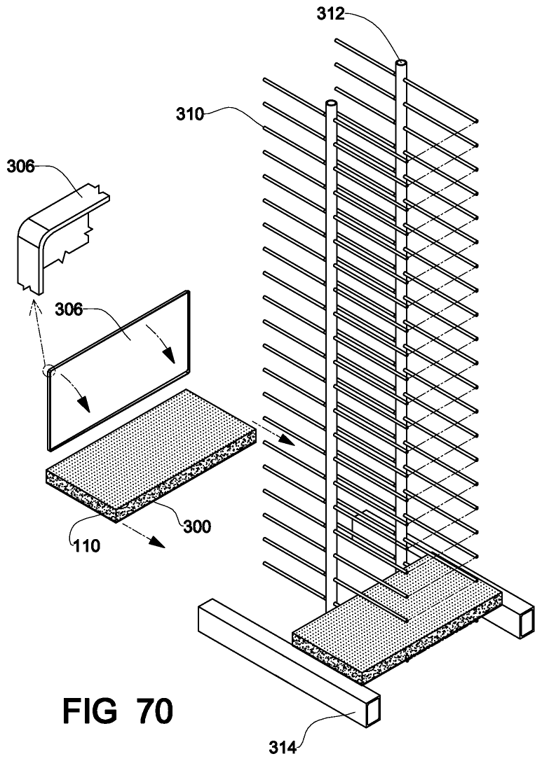

FIG. 70: Wet side-panel 110 with pallet 300 or pan 302 is covered with sheet (steel or plastic) 306 and placed in curing-rack 314, 310, 312 for minimum 7 days. The mold cover sheet 306 can have rounded/sharp edges (like a cookie cutter) and/or engravings to act as “design pressed/stamped concrete” on the side-panels exposed surface.

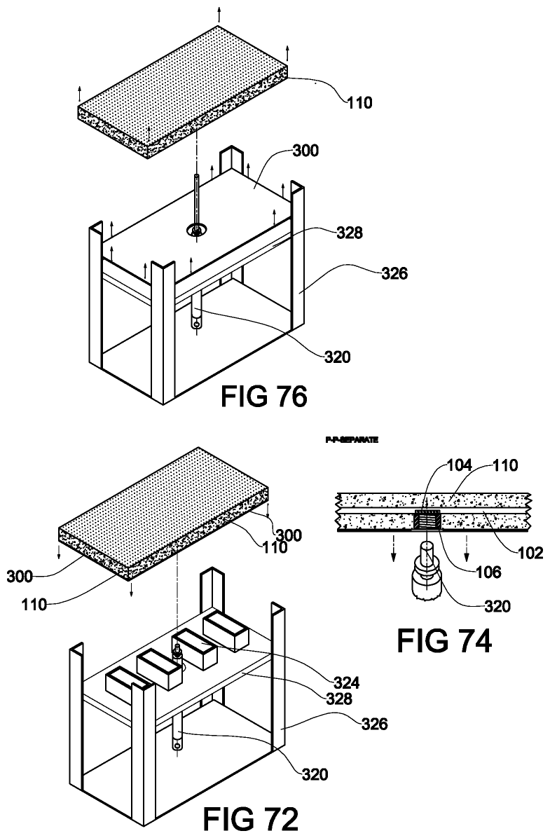

FIG. 72: Panel with steel pallet or steel pan set on electromagnets to hold the steel while the hydraulic cylinder 320 stem engages side-panel anchor-nut 106.

FIG. 74: Detail: cylinder rod 320 engages side-panel anchor-nut 106.

FIG. 76: Side-panel 110 removed from pallet 300 by hydraulic cylinder 320, pallet held by electromagnets 324.

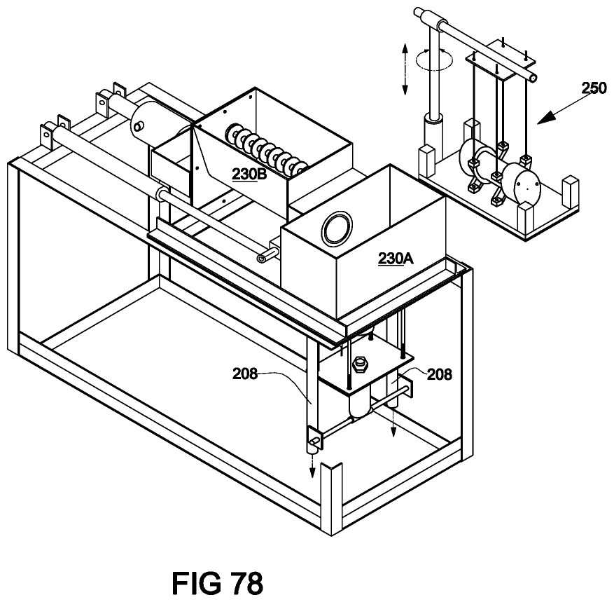

FIG. 78: Side-panel machine with mixer-compactor 230 extended forward and vibrator 250 rotated 90 degrees for total machine wash-down thru mixer-compactor 230A/230B, mold 204/202 and drain-pipes 208.

### Manufacture of Side-Panel Reinforcing Steel

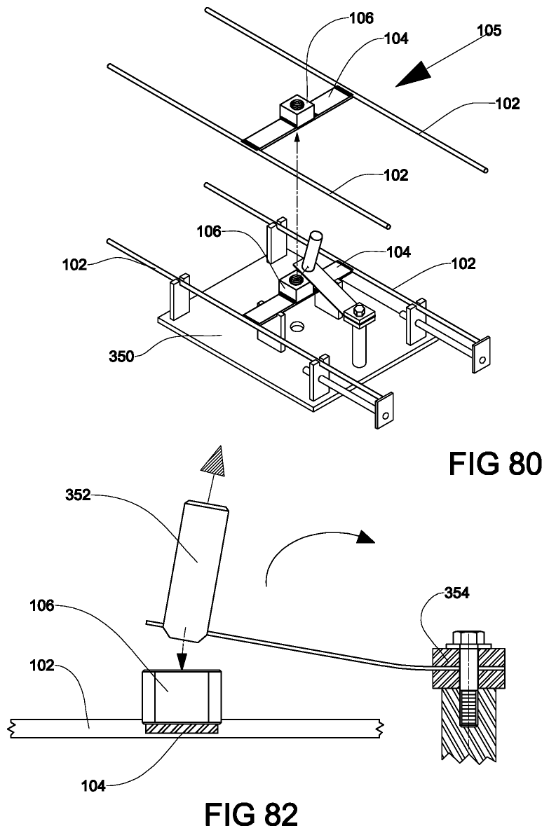

FIG. 80: Welding jig to make panel reinforcement 105. Steel ¼″×18″ rod 102, flat bar 6″×1″×⅛″ 104, square anchor-nut ¾-10 106. Pin and spring-strip 352 to clamp anchor-nut 106 to flat bar 104 to facilitate 4 each weld passes.

FIG. 82: Detail of spring clamp to hold anchor-nut 106 In place for welding.

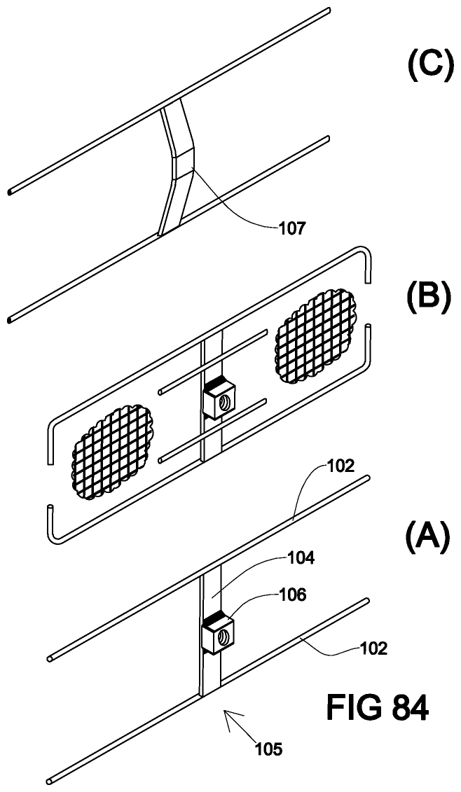

FIG. 84: Panel reinforcement: (A) preferred embodiment 105, (B) extra strength, (C) bent flat for direct welding of tie-rod 107.

### Side-Panel Testing Appartus

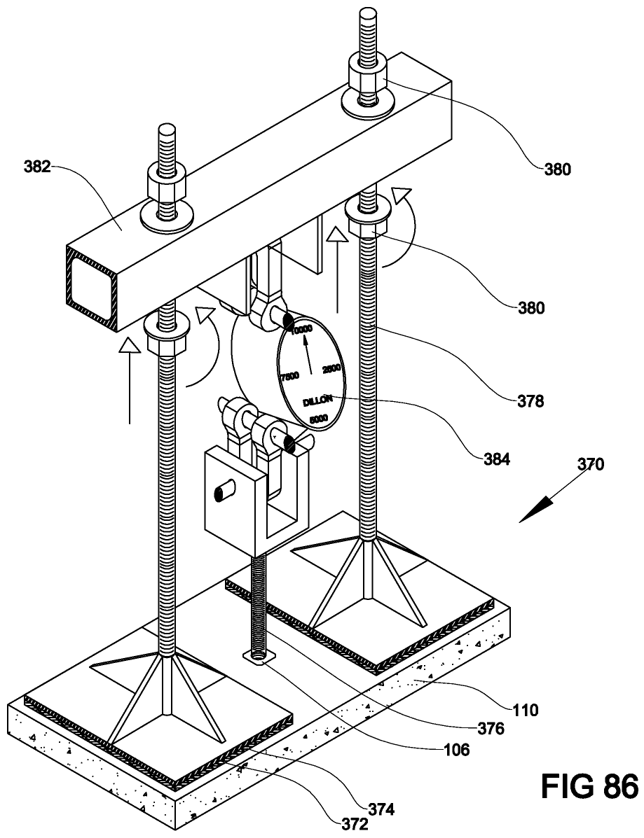

FIG. 86: Panel testing apparatus to measure the tensile strength of tie-rod anchor-nut connection, and the panel bending resistance. The side-panel is loaded by threaded-rod 376 screwed into anchor-nut 106. Force is applied by turning with a wrench the 2 each lower drive nuts 380 to raise and load the steel HSS 382 beam. The center of beam 382 has a bracket to “U-joint-pin” attach a Dilion dial load-cell 384 with a range of 0 to 10,000 lbs. (45,000 N). A similar “U-joint-pin” then connects the Dilion to a ¾-10 threaded-rod 376 which is screwed into the panel anchor-nut 106. The compressive load is transmitted thru the 2 each “jacking-screw” 3/4¾-10 threaded-rod to 2 each 9″×7″×¼″ steel plate and ¼″rubber-pads. This simulates field wet concrete placement and vibration pressure stresses.

### Fixture To Manufacture Construction-Block By Welding

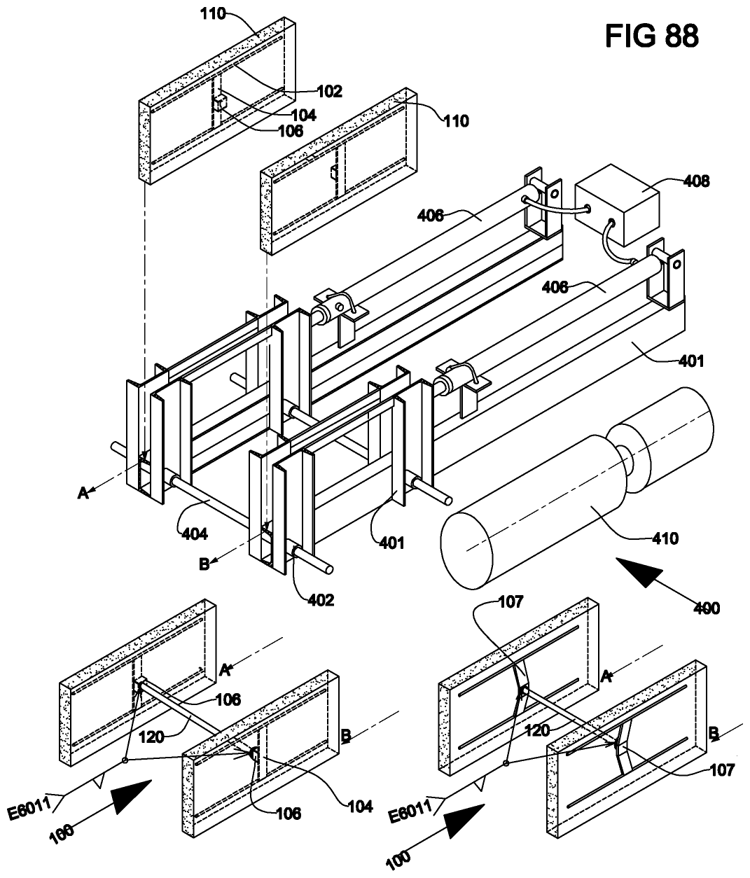

FIG. 88: A welding fixture 400 to hold two panels in alignment (to counter welding distortion) for either manual or automatic arcwelding (not shown). The desired block width is set by moving frame “A” and “B” along rod 404 and locking into position by collars or nuts on a threaded rod. Two side-panels are Inserted from the top and a ⅝″ (16 mm) diameter tie-rod (usually a #5 weldable rebar) is inserted either into a 106 anchor-nut (¾-10, used as a ⅝″ welding sleeve), or positioned (not shown) for the side-panel 107 steel bent-strip. As the welding will cause some of the panels 110 to wedge against the alignment-fixture, two synchronized hydraulic cylinders, 24″ stroke, 406 eject the construction block 100. A hydraulic rotary flow divider 406 ensures that the two cylinders 406 move equally so as not to damage the construction block 100. A 2 Hp electric power unit (reservoir, motor, pump, valves) 410 power the hydraulic cylinders 406.

### Alternate High-Volume Side-Panel Manufacture

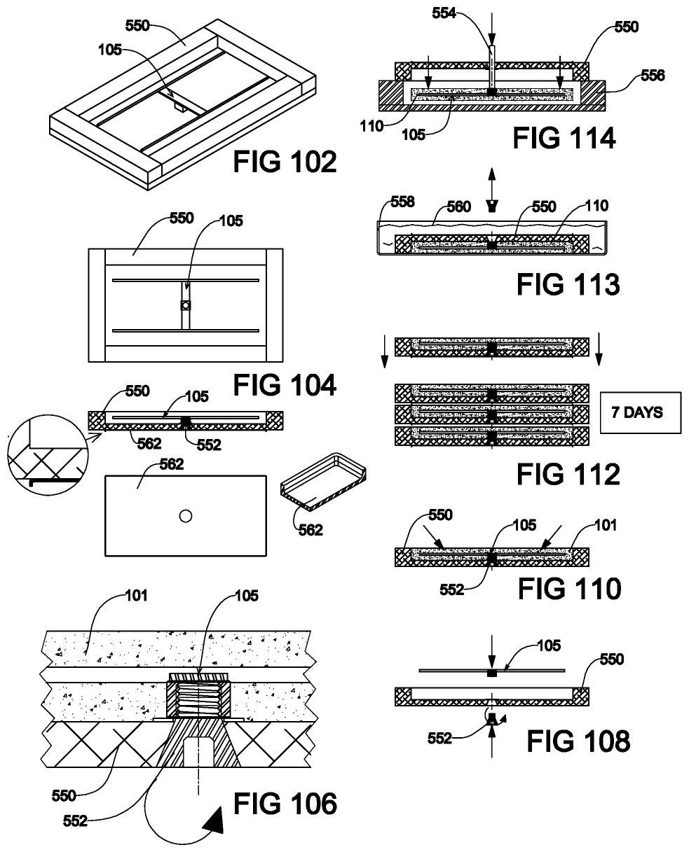

FIGS. 102 & 104: An alternate manufacture method is a flat-rectangle mold 550 of either wood, plastic or steel.

FIGS. 106 & 108: A flat-head screw 552 secures anchor-nut side-panel reinforcement 105 to bottom of mold 550.

FIG. 110: Mold 550 filled and screeded with wet sand-cement mix.

FIG. 112: Filled mold 550 stacked for 7 days for 75% strength cure. The bottom of the upper mold covers the top of the below mold to prevent water loss and ensure complete hydration curing.

FIG. 113: Mold 550 with harden side-panel 110 rotated 180 degrees to remove flat-head screw 552 and to submerge the filled mold 550 & 110 in water to expand the wood mold for side-panel release.

FIG. 114: Mold and side-panel 550 & 110 set on frame 556 to remove side-panel with pin 554.

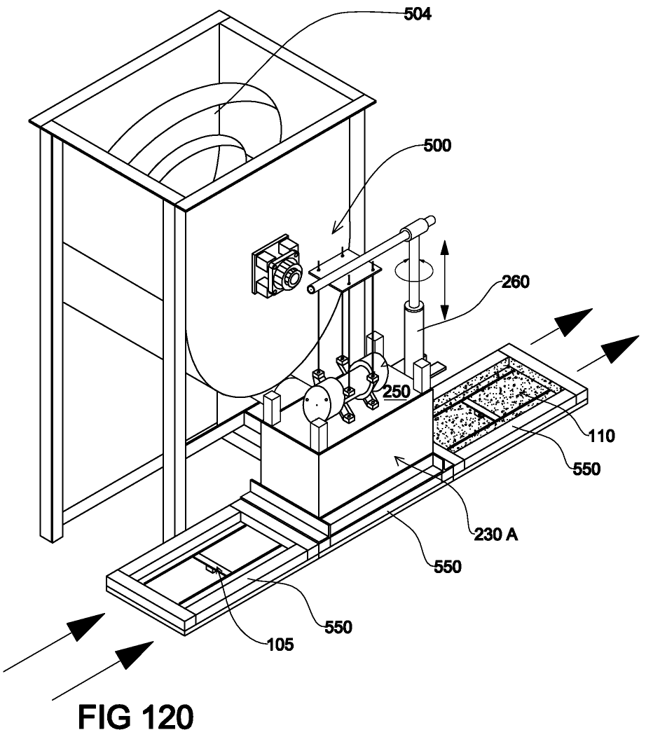

FIG. 120: Filling the flat rectangular mold 550 from a horizontal drum spiral mixer 500. A Ø4″ (100 mm) auger feeds from the drum bottom into the compactor-box 230A. Vibration unit 250 is lower by hydraulic-cylinder 260 and wire-rope 288 into compactor box 230A to compact the sand-cement-water mixture into mold 550. The tandem molds are advanced one-at-time for a continuous casting process.

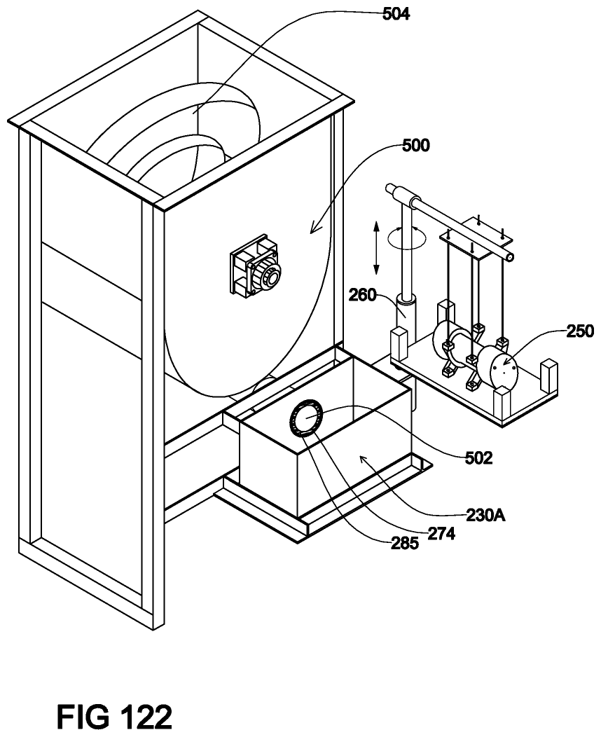

FIG. 122: Spiral 504 mixer 500 with vibration compactor 250 rotated 90 degrees for wash-down and cleaning. Mix-discharge Ø4″ auger 274, cylindrical Delrin bearing 285, and auger Ø5″ pipe casing 502 coming from the drum bottom to the compactor-box 230A are indicated.

Whereas the preferred embodiments are illustrated and described, variations may be made without deviating from the concept.

1. A permanent concrete form (construction-block form) for reinforced concrete comprising: two opposing parallelogram steel reinforced concrete (sand-cement) side-panels, screw or weld connected by a single center perpendicular steel tie-rod of varying length to create building wall thickness to accommodate structural concrete, rebar, thermal-insulation, electrical/mechanical embeds.

2. A construction-block form of claim 1 wherein the typical nominal size of L500 mm×H250 mm×Tie-bar Width and 25 kg weight is suitable for human or machine manipulation.

3. A construction-block form of claim 1 whereby the single threaded tie-rod connection allows one side-panel to be rotated or removed to fit thru congested rebar and/or other obstructions.

4. A construction-block form of claim 1 whereby the form-block is intended mainly for mortar-less erection using shims and adhesives for leveling, however the side-panel edge will permit a mortar bed.

5. A construction-block form of claim 1 whereby the steel arrangement of rods, bar, anchor-nut, and assembled with a welding-jig is suitable for cantilever side-panel strength for concrete casting loads.

6. A construction-block form of claim 1 whereby a side-panel manufacturing machine comprising: an auger mixer-compactor slider, electric-vibration plate, fixed-mold, hydraulic side-panel eject; and requires only one or two persons to operate.

7. A construction-block form of claim 1 whereby an electromagnetic clamp precisely positions and holds the reinforcing anchor-nut during side-panel mold casting.

8. A construction-block form of claim 1 whereby a welding fixture comprising to align and hold two side-panels for manual/automatic arc-welding of a tie-rod to make a complete fixed-width construction-block, which is then hydraulically ejected.

9. An optional continuous side-panel casing machine comprising: individual molds, a drum-mixer, drum bottom auger into compaction-box, electric-vibration plate; molds stacked for 7 days for 75% cure strength.

10. A side-panel testing apparatus comprising: to load the side-panel anchor-nut in tension by rotating nuts on two jack-screws, load measured by a dial-indicator.
